(19) United States
(12) Patent Application Publication
(10) Pub. No.: US 2011/0250961 A1
(43) Pub. Date: Oct. 13, 2011

(54) METHOD OF GAMING, A GAMING SYSTEM AND A GAME CONTROLLER

(76) Inventors: Daniel Julio Montenegro, Endeavour Hills (AU); Aaron James Pratt, Cranbourne West (AU)

(21) Appl. No.: 13/049,711

(22) Filed: Mar. 16, 2011

(30) Foreign Application Priority Data
Apr. 9, 2010 (AU) 2010901519

(51) Int. Cl. A63F 13/00

(52) U.S. Cl. 463/31

(57) ABSTRACT

A method of gaming comprising displaying a region comprising a plurality of symbol display positions on an electronic display, each symbol display position occupiable by one symbol at a time and being adjacent to at least one other symbol display position such that any movement of the symbols within the region involves a movement to an adjacent display position; populating at least part of the region by injecting symbols into the region at respective selected entry points of a plurality of possible entry points to the region in a respective direction of entry, each entry point corresponding to one of the symbol display; and evaluating the populated region to determine whether to make an award upon an evaluation condition being met.

### RELATED APPLICATIONS

This application claims priority to Australian Patent Application No. 2010901519, having a filing date of Apr. 9, 2010, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The invention relates to a method of gaming, a gaming system and a game controller.

Gaming systems are known where symbols are selected for display at a plurality of symbol display positions. While such gaming systems provide players with enjoyment, a need exists for alternative gaming systems in order to maintain or increase player enjoyment.

### BRIEF SUMMARY OF THE INVENTION

In a first aspect, the invention provides a method of gaming comprising:

displaying a region comprising a plurality of symbol display positions on an electronic display, each symbol display position occupiable by one symbol at a time and being adjacent to at least one other symbol display position such that any movement of the symbols within the region involves a movement to an adjacent display position;

populating at least part of the region by injecting symbols into the region at respective selected entry points of a plurality of possible entry points to the region in a respective direction of entry, each entry point corresponding to one of the symbol display positions and the plurality of entry points collectively providing at least two different directions of entry,

each symbol injected into the region displacing any symbol occupying the symbol display position corresponding to the respective entry point and any further symbols at symbol display positions contiguous thereto in the respective direction of entry of the injected symbol, such that each displaced symbol either exits the region or moves, at least initially, into an adjacent symbol position in the entry direction of the injected symbol,

wherein any symbol continues to move upon being moved to an intermediate symbol display position having an empty adjacent symbol display position to which the respective symbol can move with a displacement having a component in a defined attraction direction, and

wherein one or more of the symbol display positions are terminal symbol display positions from which symbols cannot be displaced in the attraction direction such that any symbol moving in the attraction direction will come to rest either at a terminal display position or at an unoccupied symbol display position where the moving symbol cannot move further in the attraction direction because the moving would require displacement of a symbol from a terminal display position with a component in the attraction direction; and evaluating the populated region to determine whether to make an award upon an evaluation condition being met.

In an embodiment, the evaluation condition is that all of the symbol display positions of the region are populated.

In an embodiment, the evaluation condition comprises a designated number of symbols having been injected into the region.

In an embodiment, the attraction direction is towards a bottom of the region.

In an embodiment, each symbol display position is a rhomboid and a subset of the symbol display positions provide a plurality of terminal display positions and a base upon which the remainder of the symbol display positions are stacked to define a plurality of rows of symbol display positions, an axis of each row crossing the axis of at least one other row transversely such that each row defines a slope down which symbols move when moving toward the direction of attraction.

In an embodiment, the entry points are into each symbol display position in the base row of symbol display positions.

In an embodiment, there are entry points in two directions into at least one of the symbol display positions in the base row of symbol display positions.

In an embodiment, there are entry points in two directions into each one of the symbol display positions in the base row of symbol display positions.

In an embodiment where the attraction direction is towards the bottom of the region, the symbol display positions are arranged in a rectangular array.

In an embodiment, the attraction direction is towards a top of the region. In such an embodiment the symbol display positions may also be arranged in a rectangular array.

In an embodiment, the method comprises randomly selecting the entry point for each symbol.

In an embodiment, the method comprises randomly selecting the direction of entry for each symbol.

In an embodiment, the method comprises randomly selecting each symbol from a set of symbols.

In an embodiment, the method comprises displaying a symbol outside each region at each entry point such that a player can see each symbol which may be injected into the region.

In a second aspect, the invention provides a gaming system comprising:

an electronic display displaying a region comprising a plurality of symbol display positions on an electronic display, each symbol display position occupiable by one symbol at a time and being adjacent to at least one other symbol display position such that any movement of the symbols within the region involves a movement to an adjacent display position;

a symbol injector arranged to populate at least part of the region by injecting symbols into the region at respective selected entry points of a plurality of possible entry points to the region in a respective direction of entry, each entry point corresponding to one of the symbol display positions and the plurality of entry points collectively providing at least two different directions of entry;

a symbol displacement controller arranged to control displacement of symbols such that each symbol injected into the region displaces any symbol occupying the symbol display position corresponding to the respective entry point and any further symbols at symbol display positions contiguous thereto in the respective direction of entry of the injected symbol, such that each displaced symbol either exits the region or moves, at least initially, into an adjacent symbol position in the entry direction of the injected symbol,

the symbol displacement controller further arranged such that any symbol continues to move upon being moved to an intermediate symbol display position having an empty adjacent symbol display position to which the symbol can move with a displacement having a component in a defined attraction direction, wherein one or more of the symbol display positions are terminal symbol display positions from which symbols cannot be displaced in the attraction direction such that the symbol displacement controller causes any symbol moving in the attraction direction to come to rest either at a terminal display position or at an unoccupied symbol display position where the moving symbol cannot be moved further in the attraction direction because the moving would require displacement of a symbol from a terminal display position with a component in the attraction direction; and

a region evaluator, arranged to evaluate the populated region to determine whether to make an award upon an evaluation condition being met.

In an embodiment, the evaluation condition is that all of the symbol display positions of the region are populated.

In an embodiment, the evaluation condition comprises a designated number of symbols having been injected into the region.

In an embodiment, the attraction direction is towards a bottom of the region.

In an embodiment, each symbol display position is a rhomboid and a subset of the symbol display positions provide a plurality of terminal display positions and a base upon which the remainder of the symbol display positions are stacked to define a plurality of rows of symbol display positions, an axis of each row crossing the axis of at least one other row transversely such that each row defines a slope down which symbols move when moving toward the direction of attraction.

In an embodiment, the entry points are into each symbol display position in the base row of symbol display positions.

In an embodiment, there are entry points in two directions into at least one of the symbol display positions in the base row of symbol display positions.

In an embodiment, there are entry points in two directions into each one of the symbol display positions in the base row of symbol display positions.

In an embodiment, the symbol display positions are arranged in a rectangular array.

In an embodiment, the attraction direction is towards a top of the region.

In an embodiment, the symbol display positions are arranged in a rectangular array.

In an embodiment, the symbol injector is arranged to randomly select the entry point for each symbol.

In an embodiment, the symbol injector is arranged to randomly select the direction of entry for each symbol.

In an embodiment, the symbol injector is arranged to randomly select each symbol from a set of symbols.

In an embodiment, the gaming system is further arranged to display a symbol outside each region at each entry point such that a player can see each symbol which may be injected into the region.

In a third aspect, the invention provides a game controller for a gaming system, the game controller arranged to:

control an electronic display to display a region comprising a plurality of symbol display positions, each symbol display position occupiable by one symbol at a time and being adjacent to at least one other symbol display position such that any movement of the symbols within the region involves a movement to an adjacent display position;

populate at least part of the region by injecting symbols into the region at respective selected entry points of a plurality of possible entry points to the region in a respective direction of entry, each entry point corresponding to one of the symbol display positions and the plurality of entry points collectively providing at least two different directions of entry,

each symbol injected into the region displacing any symbol occupying the symbol display position corresponding to the respective entry point and any further symbols at symbol display positions contiguous thereto in the respective direction of entry of the injected symbol, such that each displaced symbol either exits the region or moves, at least initially, into an adjacent symbol position in the entry direction of the injected symbol,

wherein any symbol continues to move upon being moved to an intermediate symbol display position having an empty adjacent symbol display position to which the respective symbol can move with a displacement having a component in a defined attraction direction, and

wherein one or more of the symbol display positions are terminal symbol display positions from which symbols cannot be displaced in the attraction direction such that any symbol moving in the attraction direction will come to rest either at a terminal display position or at an unoccupied symbol display position where the moving symbol cannot move further in the attraction direction because the moving would require displacement of a symbol from a terminal display position with a component in the attraction direction; and

evaluate the populated region to determine whether to make an award upon an evaluation condition being met.

In an embodiment, the evaluation condition is that all of the symbol display positions of the region are populated.

In an embodiment, the evaluation condition comprises a designated number of symbols having been injected into the region.

In an embodiment, the game controller is arranged to randomly selecting the entry point for each symbol.

In an embodiment, the game controller is arranged to randomly selecting the direction of entry for each symbol.

In an embodiment, the game controller is arranged to randomly selecting each symbol from a set of symbols.

In an embodiment, the game controller is arranged to control the display to display a symbol outside each region at each entry point such that a player can see each symbol which may be injected into the region.

In a fourth aspect, the invention provides a gaming system comprising:

means for displaying a region comprising a plurality of symbol display positions, each symbol display position occupiable by one symbol at a time and being adjacent to at least one other symbol display position such that any movement of the symbols within the region involves a movement to an adjacent display position;

means for populating at least part of the region by injecting symbols into the region at respective selected entry points of a plurality of possible entry points to the region in a respective direction of entry, each entry point corresponding to one of the symbol display positions and the plurality of entry points collectively providing at least two different directions of entry,

each symbol injected into the region displacing any symbol occupying the symbol display position corresponding to the respective entry point and any further symbols at symbol display positions contiguous thereto in the respective direction of entry of the injected symbol, such that each displaced symbol either exits the region or moves, at least initially, into an adjacent symbol position in the entry direction of the injected symbol,

wherein any symbol continues to move upon being moved to an intermediate symbol display position having an empty adjacent symbol display position to which the respective symbol can move with a displacement having a component in a defined attraction direction, and

wherein one or more of the symbol display positions are terminal symbol display positions from which symbols cannot be displaced in the attraction direction such that any symbol moving in the attraction direction will come to rest either at a terminal display position or at an unoccupied symbol display position where the moving symbol cannot move further in the attraction direction because the moving would require displacement of a symbol from a terminal display position with a component in the attraction direction; and

means for evaluating the populated region to determine whether to make an award upon an evaluation condition being met.

In a fifth aspect, the invention provides computer program code which when executed implements the above method.

In a sixth aspect, the invention provides a tangible computer readable medium comprising the above program code.

In a seventh aspect, the invention extends to transmitting the above program code.

### BRIEF DESCRIPTION OF SEVERAL VIEWS OF THE DRAWINGS

An exemplary embodiment of the invention will now be described with reference to the accompanying drawings in which:

FIG. 1 is a block diagram of the core components of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of a gaming system;

FIG. 7 is a flow chart of an embodiment;

FIGS. 8a to 8u show an example of populating a region;

FIG. 9 is an example of an alternative region;

FIG. 10 is a further example of an alternative region; and

FIG. 11 is a further example of an alternative region.

### DETAILED DESCRIPTION OF THE INVENTION

Referring to the drawings, there is shown a gaming system having a game controller arranged to implement a game where a region made up of a plurality of symbol display positions is displayed. At least part of the region, and advantageously the whole region, is populated by injecting symbols into the region at entry points. As symbols are injected, they may displace symbol already within the region. The region has a defined attraction direction. Symbols which occupy an intermediate symbol position (e.g. as a result of a displacement) where there is an empty position generally in the attraction direction will move to the empty position. The region is evaluated when an evaluation condition such as the completion of the population of the region is met. An award is made to a player upon a win condition being met by the evaluation.

### General Construction of Gaming System

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

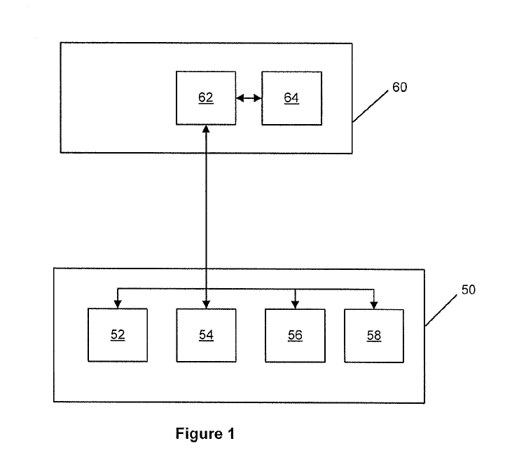

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions to play the game and observe the game outcomes.

Components of the player interface may vary from embodiment to embodiment but will typically include a credit mechanism 52 to enable a player to input credits and receive payouts, one or more displays 54, a game play mechanism 56 including one or more input devices that enable a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play rules are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor using an application specific integrated circuit (ASIC) or a field programmable gate array (FPGA).

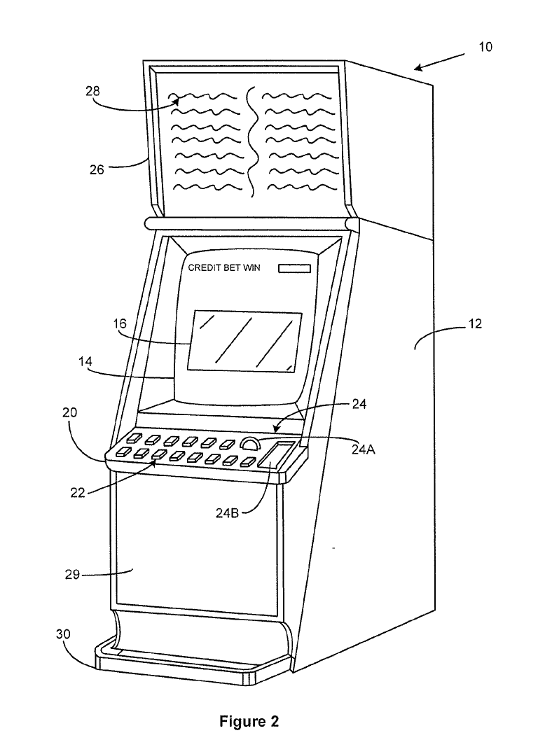

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable electronic video display unit. The top box 26 may also include a display, for example a video display unit, which may be of the same type as the display 14, or of a different type.

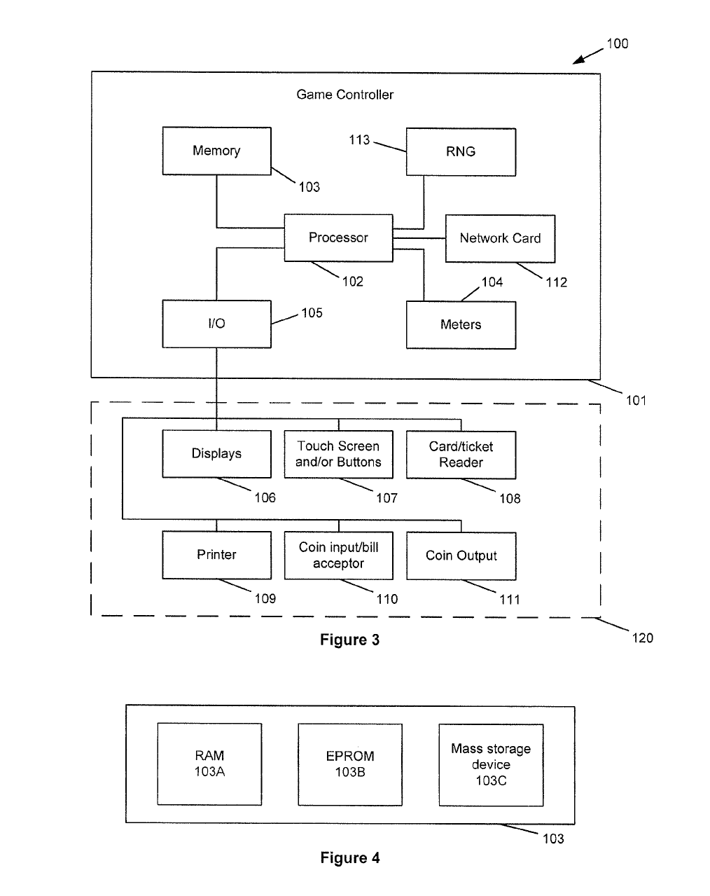

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

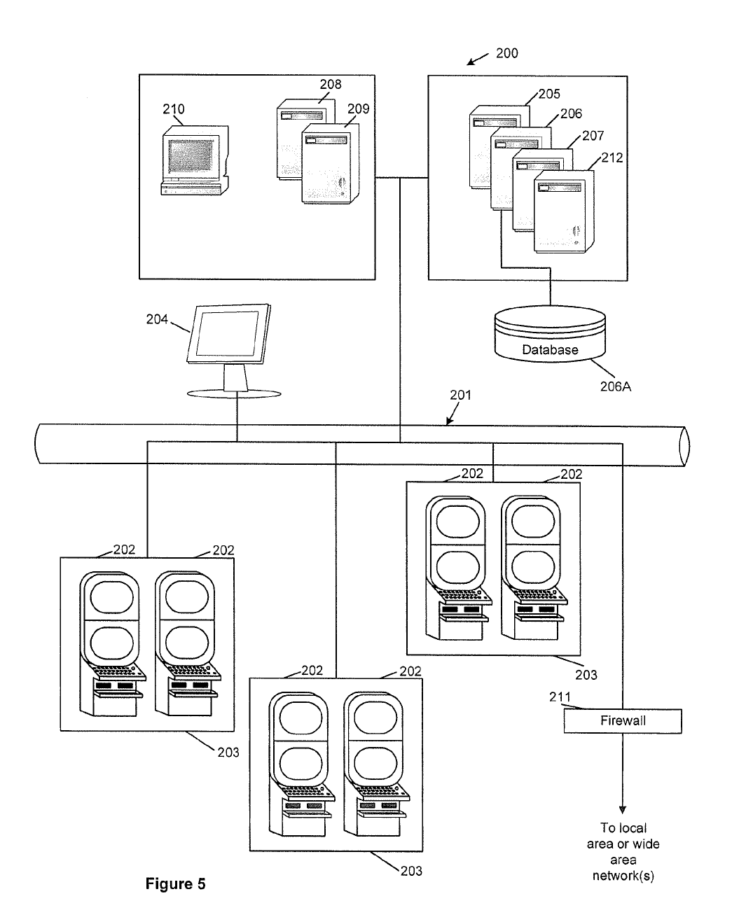

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

### Further Detail of Gaming System

The player operates the game play mechanism 56 to specify a wager which will apply this play of the game and initiates a play of the game. The game controller 60 then begins a play of the game.

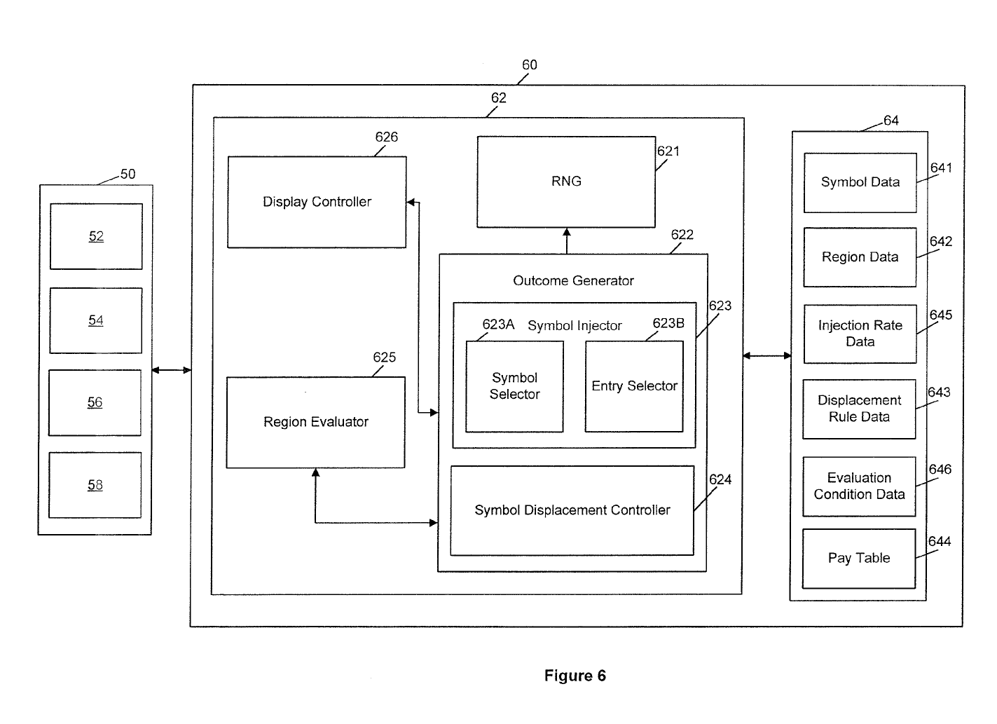

In FIG. 6, the processor 62 of game controller 60 is shown implementing a number of modules based on program code and data stored in memory 64. Persons skilled in the art will appreciate that various of the modules could be implemented in some other way, for example by a dedicated circuit.

After the game begins, the outcome generator 622 begins to generate an outcome of the game to be evaluated by the region evaluator 625. Before the outcome generator 622 operates, display controller 626 controls the display to display a region comprising a plurality of symbol display positions specified by region data 642.

Once the region is displayed, the symbol injector 623 of outcome generator 622 begins to operate. In the embodiment, this involves the symbol selector 623A conducting an initial operation in which it selects a plurality of symbols to display at a plurality of entry points to the region the entry points specified by the region data. Each entry point has at least one associated direction. The symbols are selected randomly from a set of symbols specified by the symbol data using RNG 621. After the initial selection of symbols, the entry selector 623B of the symbol injector 623 selects one of the entries at which to insert a symbol into the region of symbol display positions. The symbol displacement controller 624, then controls the movement of this symbol into the region. Symbols move within the region moving between adjacent symbol display positions.

Depending on the embodiment, the symbol may be able to move additionally once inserted. If so, this is also controlled by the symbol displacement controller 624 in accordance with the displacement rule data 643. After the initial symbol has moved into the region. The symbol selector 623A selects a symbol to replace the injected symbol to be displayed at the entry point used by the previously injected symbol. The entry selector 623B then selects a further symbol for injection into the region.

In the embodiment, the entries are selected in accordance with injection rule data 625, which specifies, in the embodiment each of the entries is to be selected randomly by the entry selector 623B. Accordingly, the entry selector 623B obtains a random number from random number generator 621 in order to select the entry (for example, by comparing the obtained random numbers to ranges of random numbers associated with respective entries). It will be appreciated that in other embodiments, there may be additional rules regarding selection of the entry in order to control, to some extent, the population of the region while still retaining some random element. For example in an initial phase of injection, symbols could be injected by selecting from a subset of the entry points or, in an alternative embodiment, while the entry point could be known and correspond to one of the symbol display positions, the direction of entry could be selected at random.

In the embodiment any symbol which is injected into the region at a position already occupied by a symbol will displace that symbol in any other symbols along the line contiguous thereto in a direction corresponding to the direction of entry of the symbol. This displacement is controlled by the symbol displacement controller 624. Some of the display positions are designated as terminal positions and these are placed within the region at a part of the region corresponding to a designated direction of attraction.

As symbols are injected into the grid, any symbol which is displaced can either be:

1. displaced out of the region; or

2. displaced to a point where it can move no further; or

3. displaced to an intermediate position where there is an empty symbol display position to which the symbol can move by displacement having a component in the direction of the attraction direction.

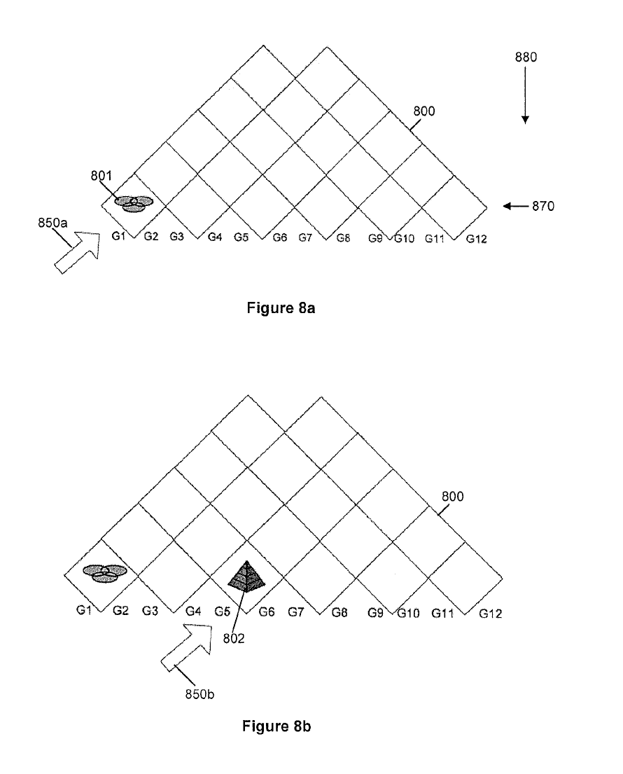

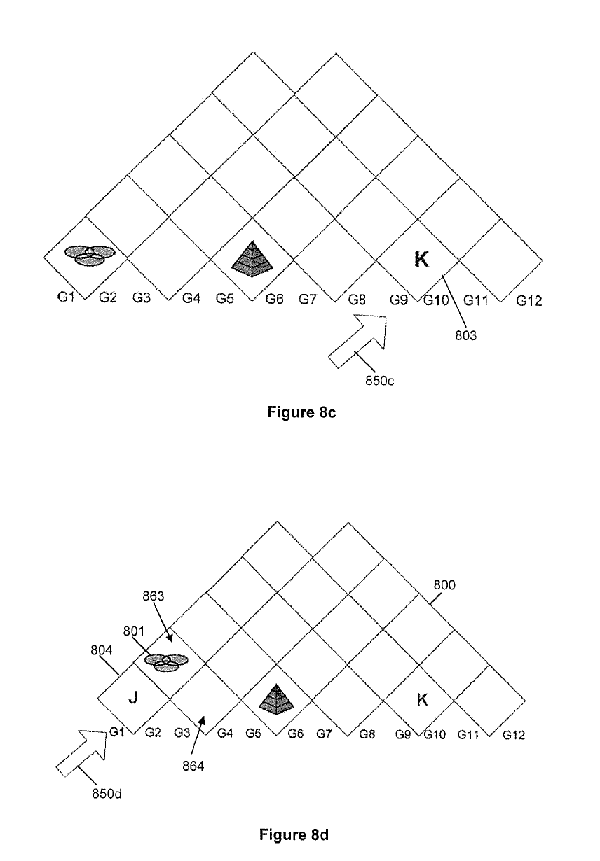

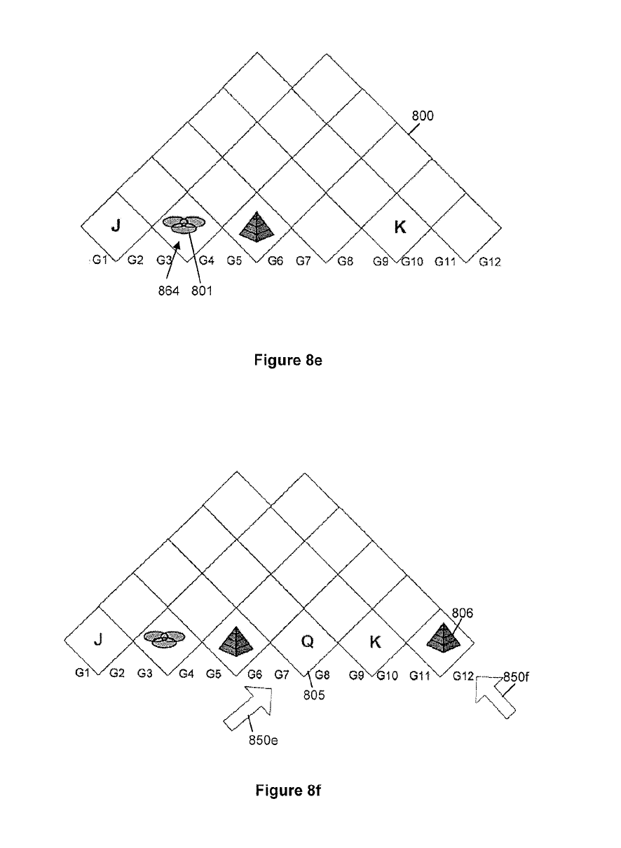

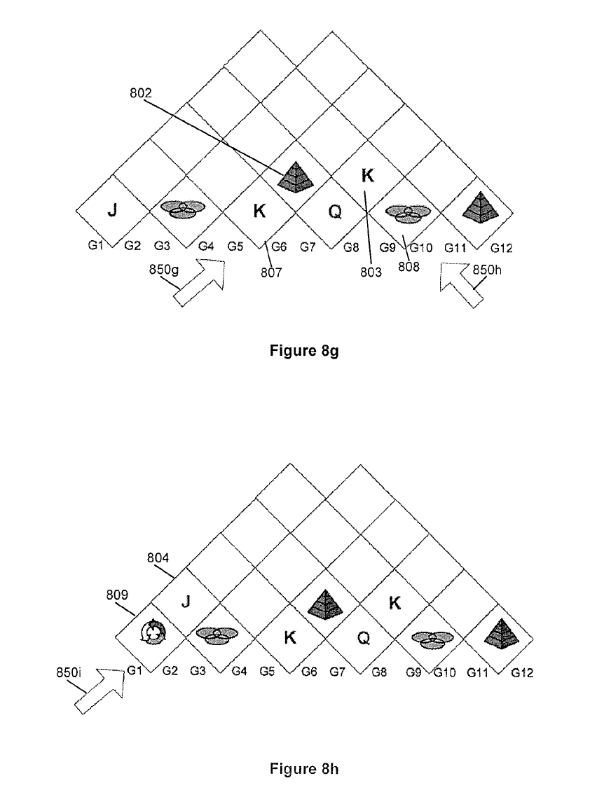

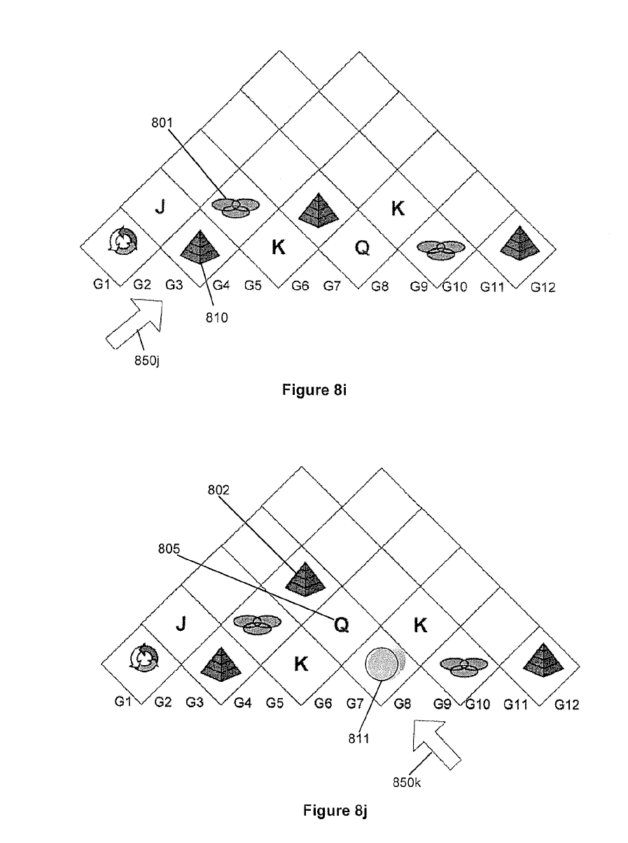

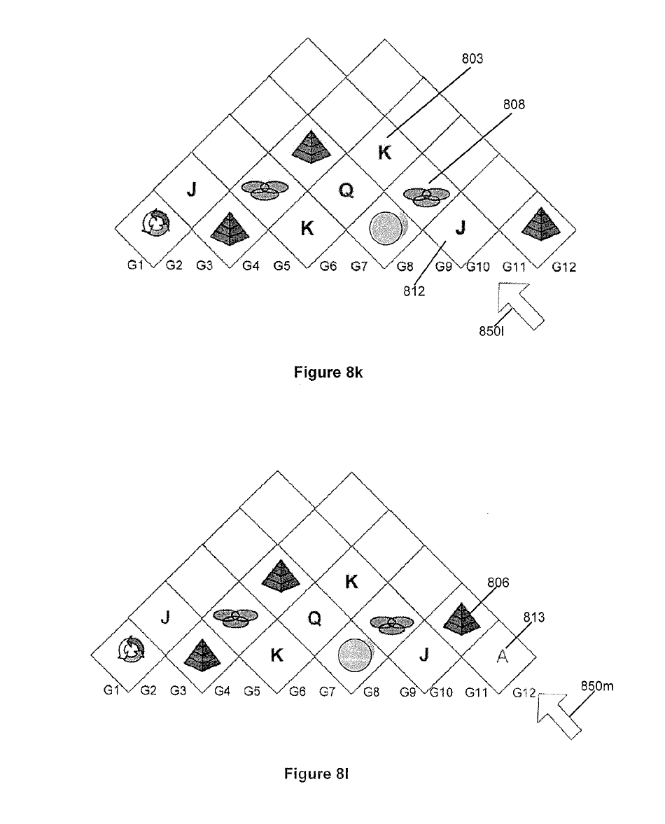

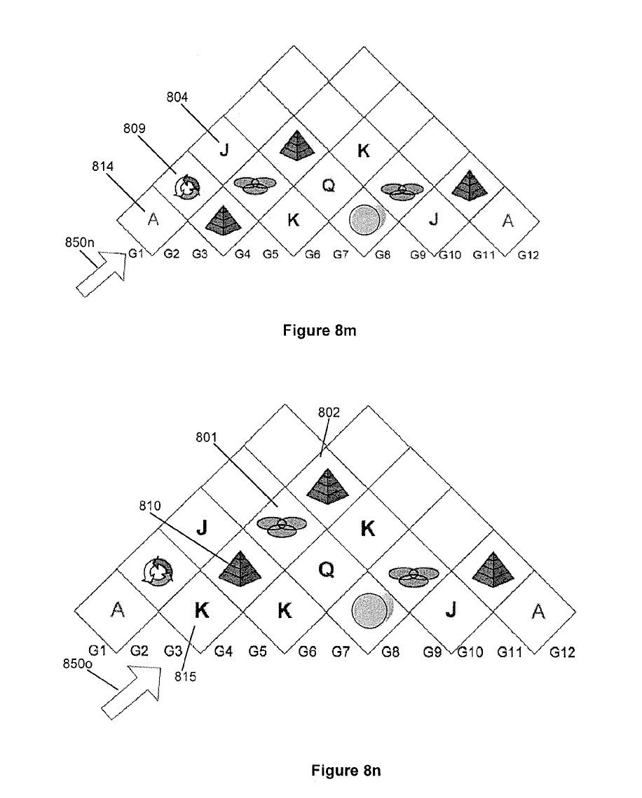

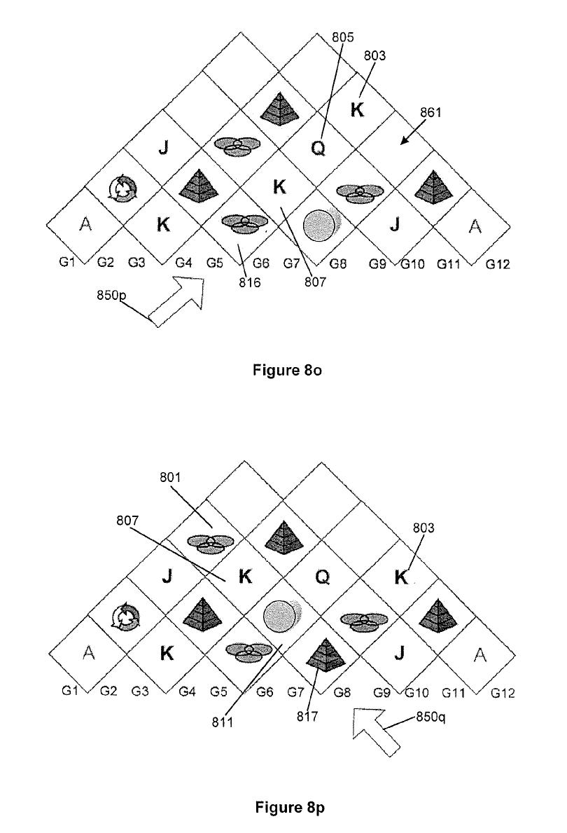

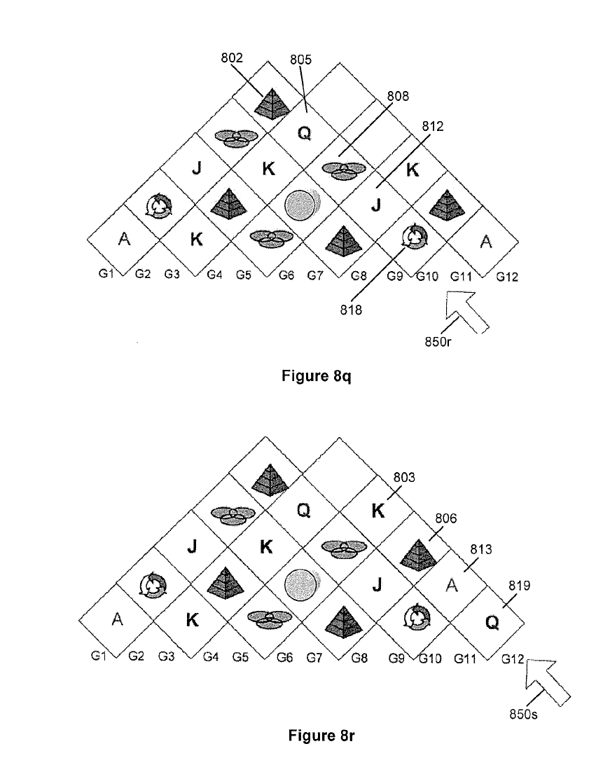

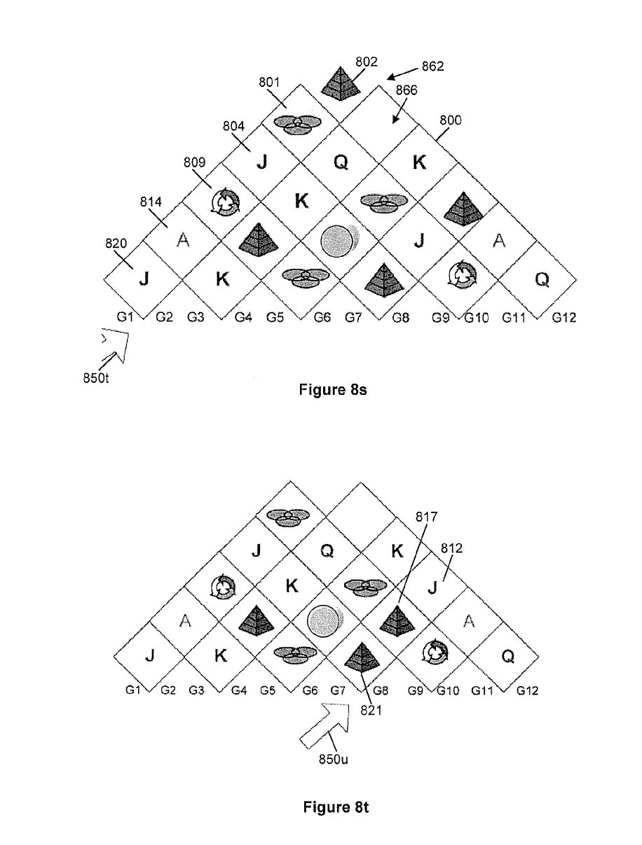

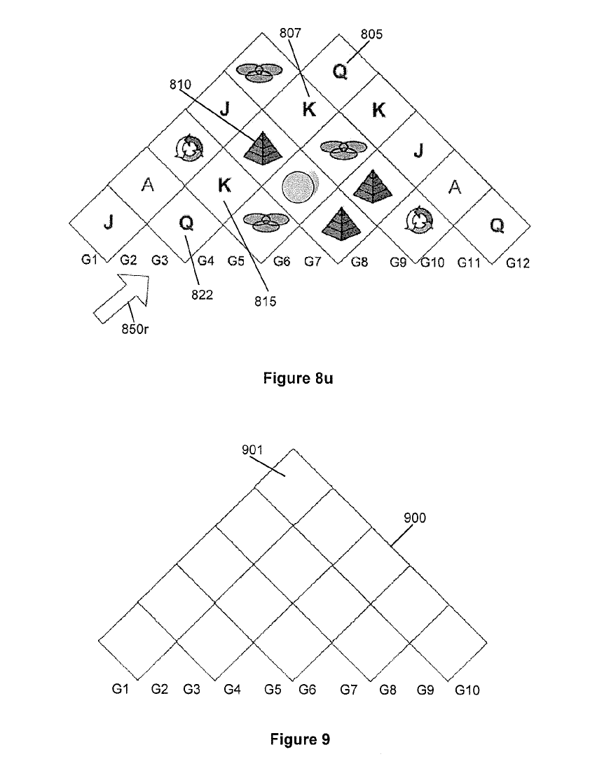

When a symbol moves to such an intermediate position, the symbol displacement controller 624 controls the movement of the symbol so that it moves in the attraction direction towards one of the terminal display positions. The symbol will either stop at a terminal display position, or at a position where, if it were to move further, it would be required to displace a symbol at a terminal display position. Such movements are described in more detail in relation to the example shown in FIG. 8.

The symbol injector and symbol displacement controller 623, 624 continue to populate the region until such time that the outcome generator 622 determines that an evaluation condition is specified by evaluation condition data 626 has been met. At such time, the region evaluator 625 evaluates the symbols at the symbol display positions in accordance with any rules and the pay table 644 to determine whether to make an award to a player. Any award is communicated to the player on the display 54 and used to update meters (not shown) stored in memory 64.

Persons skilled in the art will appreciate that there are a number of variations which can be achieved. For example in the above embodiment, the evaluation condition is that the entirety of the region has been populated. In another embodiment, a certain period of time may be allowed to elapse before the region is evaluated or a certain number of symbols may need to be injected into the region in order to determine for the evaluation condition to be met. While the above described example provides an award in the form of credits, other awards known in the arts such as free games of the gaming machine, non credit prizes etc. may be awarded. In another embodiment, certain entry points may have different probabilities.

Another variation which will be apparent to persons skilled in the art is that it is not strictly necessary to display symbols outside the region prior to their injection.

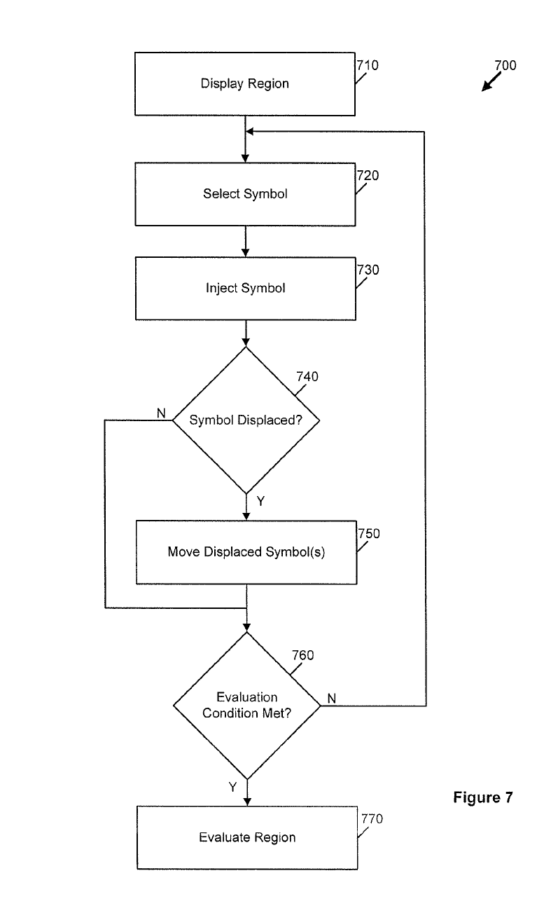

The method 700 of the embodiment is summarised in FIG. 7 and involves displaying 700 the region on display, selecting 720 a symbol and injecting a symbol 730 into the region. If a symbol is displaced 740, the displaced symbol is moved 750 it is then determined 700 whether an evaluation condition is met. Upon the evaluation condition being met, the method involves evaluating 760 the region. Normally, it will require a number of cycles before the evaluation condition will be met.

Further aspects of the method will be apparent from the above description of the system. It will be appreciated that at least part of the method will be implemented digitally by a processor. Persons skilled in the art will also appreciate that the method could be embodied in program code. The program code could be supplied in a number of ways, for example on a tangible computer readable storage medium, such as a disc or a memory (for example, that could replace part of memory 103) or as a data signal (for example, by transmitting it from a server). Persons skilled in the art, will appreciate that program code provides a series of instructions executable by the processor.

Persons skilled in the art will appreciate that in an alternative embodiment, the game may be implemented as a feature game involves some additional element of game play which only occurs when a trigger condition is met in a base game. The trigger event may be, a symbol combination in the game, occurrence of a specific symbol in the game, purchased, be caused by another connected system, based on turnover, based on a random evaluation, etc.

### EXAMPLES

### Example 1

Referring to FIG. 8, the display controller 626 has controlled display 54 display a region 800 having 20 symbol display positions. The symbol display positions are rhomboid in shape and there is a base 870 of six symbol display positions upon which the other symbol display positions are stacked in an adjacent relationship such that five symbol display positions are stacked on the base of six symbols, four symbol display positions are stacked on top of that followed by three and two symbol display positions respectively. The base 870 of six symbol display positions provide the terminal display positions such that any symbol position which is at a terminal position will not move further in the attraction direction 880 which is towards the base 870 of the region 800. That is, symbols will not move from the terminal positions out of the region in the attraction direction but may move out of the region in other directions.

A plurality of entry points in the form of gates G1 to G12 are provided at the base 870. That is, each symbol display position 870 of the base has two gates. It will be appreciated that on other embodiments not every symbol display position need have two gates. In this embodiment, the gates correspond to two different directions of entry into the relevant symbol display positions by symbols. These correspond to the two sides of each rhomboid along the base such that symbols, in effect, enter from these sides in a direction transverse to the respective side.

It will appreciated in particular that rather than two gates being provided for the end symbol display positions—i.e. G1, G2 and G11, G12, single gates could be provided, for example G1 and G12.

It will be apparent from FIG. 8 that the symbol display positions define a plurality of rows along which symbols can move if displaced by another symbol in the direction of entry of that symbol and that various of the rows cross one another. This allows symbols to move down the slopes defined by the rows when they move to a position where there is an empty symbol display position below them in the direction of the attraction direction 880.

Two conventions are adopted in the description of FIGS. 8a to 8u. Firstly for each injection of a symbol, an arrow is provided at the relevant gate where the symbol is to enter pointing in the direction of entry. Each such arrow is labelled 850 followed by a letter of the alphabet. The letter to the alphabet indicating the order of injection. Each symbol which is injected is also numbered consecutively starting at 801.

Referring to FIG. 8a as indicated by arrow 850a a green flower symbol 801 selected by symbol selector 623a has been injected into the region 800 at Gate 9 selected by entry selector 623B.

FIG. 8b shows a blue pyramid symbol 802 being injected as indicated in the direction indicated by arrow 850b. It will appreciated that in initial insertions, the direction of injection is of little importance but this becomes more important as the region 800 becomes more completely populated.

FIG. 8c shows that a king symbol 803 has been injected through gate 9 in the direction indicated by arrow 850c.

FIG. 8d shows that a jack symbol 804 has been inserted into the region 800 as indicated by arrow 850d. The insertion of the jack symbol 804 is to a position occupied by another symbol, accordingly symbol displacement controller 624 money the green flower symbol 801 to an intermediate position 863 where there is an empty symbol display position 864 to which the green flower symbol 801 can move with a component in the direction of attraction 880—i.e. down the slope defined by the symbol positions 863, 864 to an empty symbol display position 864 as if falling due to gravity.

FIG. 8e shows the green flower symbol 801 having been moved to the previously empty symbol display position 864 by the symbol displacement controller. The green flower symbol 801 does not move beyond this position because it is a terminal display position and any further movement would require the green flower symbol 801 to exit the region in the direction of attraction.

FIG. 8f shows two symbols being inserted, namely a queen symbol 805 as indicated by arrow 850e and a pyramid symbol 806 as indicated by arrow 850f. A further two symbols are inserted in FIG. 8g. First a king symbol 807 is inserted which displaces the pyramid symbol 802 along the direction indicated by arrow 850g and then a green flower symbol 808 is inserted which displaces king symbol 803 along the direction indicated by arrow 850h.

In FIG. 8h a tri-knot symbol 809 is inserted through gate 1 in the direction indicated by arrow 850i which displaces jack symbol 804.

In FIG. 8i a pyramid symbol 810 is inserted through gate 3 in the direction of arrow 850j which displaces a green flower symbol 801.

In FIG. 8j a circle symbol 811 is inserted through gate 8 in the direction indicated by arrow 850k. The injection of the circuit symbol 811 displaces queen symbol 805 and a blue pyramid symbol 802.

FIG. 8K shows a jack symbol 812 being inserted through gate 10 in the direction indicated by arrow 850l. The insertion of jack symbol 812 displaces green flower symbol 808 and in turn displaces a king symbol 803.

FIG. 8l shows an ace symbol 813 being inserted through gate 12 in the direction indicated by arrow 850m displacing blue pyramid symbol 806.

FIG. 8m shows an ace symbol 814 being inserted through gate 1 in the direction indicated by arrow 850n displacing tri-knot symbol 809 and jack symbol 804.

FIG. 8n shows a king symbol 815 being inserted through gate 3 as indicated by arrow 850o. The insertion of the king symbol 815 displaces blue pyramid symbol 810 green flower symbol 801 and blue pyramid symbol 802.

FIG. 8o shows a green flower symbol 816 being inserted in the direction of arrow 850p through gate 5. The insertion of the green flower symbol 816 displaces king symbol 807, queen symbol 805 and king symbol 803 to an intermediate symbol display position where there is an empty symbol display position 861 below the king symbol 803 in the direction of attraction 880. Accordingly, as shown in FIG. 8p, the king symbol 803 has fallen down the slope to position 861.

FIG. 8p also shows the insertion of a blue pyramid symbol 817 through gate 8 in the direction indicated by arrow 850q. The insertion of blue pyramid symbol 817 displaces circle symbol 811, king symbol 807 and green flower symbol 801.

FIG. 8q shows the insertion of a tri-knot symbol 818 through gate 10 in the direction indicated by arrow 850r. The insertion of the tri-knot symbol 818 displaces the jack symbol 812, the flower symbol 808, queen symbol 805 and blue pyramid symbol 802.

FIG. 8r shows the insertion of a queen symbol 819 through gate 12 in the direction indicated by arrow 850s. Insertion of the queen symbol 819 displaces the ace symbol 813, the blue pyramid symbol 806 and the king symbol 803.

FIG. 8s shows the insertion of a jack symbol 820 through gate 1 in the direction indicated by arrow 850t. The insertion of the jack symbol 820 displaces the ace symbol 814, the tri-knot symbol 809, the jack symbol 804 and the green flower symbol 801 to new positions within the region 800. In addition, the blue pyramid symbol 802 has been displaced to a symbol display position 862 which is outside the region 800. The symbol 802 is briefly displayed at this position 862 before being removed from the display 54 by the display controller 626. Any symbols removed from the region 800 in this way will not form part of the subsequent evaluation of the region 800. In this example, this is disadvantageous to the player because pays to the player are based on the number of blue pyramid symbols within the region 800 when it is fully populated. It will be appreciated that while position 862 is above an empty position 866 the blue pyramid symbol 802 will not move to position 866 because it has been moved outside of the region 800.

FIG. 8t shows insertion of the blue pyramid symbol 821 through gate 7 as indicated by arrow 850u. Insertion of the blue pyramid symbol 821 displaces blue pyramid symbol 817 and jack symbol 812 as well as displacing blue pyramid symbol 806 from the region.

FIG. 8u shows the insertion of Queen symbol 822 through gate 3 in the direction indicated by arrow 850v. Insertion of the queen symbol 822 by the symbol injector 623 results in the displacement by a symbol displacement controller 624 of king symbol 815, pyramid symbol 810, king symbol 807 and queen symbol 805.

At this point, the outcome generator 622 determines that the region evaluation condition has been met because the region 800 has been completely populated with symbol. The region evaluator 625 examines the symbols and compares them to a pay table and determines that a win is payable for three blue pyramids.

### Example 2

FIG. 9 shows an alternative region 900 composed of 15 symbol display positions stacked in a similar manner to that of FIG. 8. The region 900 behaves in the same manner as that of FIG. 8 but there are fewer display positions and 10 gates G1 to G10 instead of 12 gates. There is also a symbol display position 901 at the apex of the pyramid in contrast to the arrangement of FIG. 8.

### Example 3

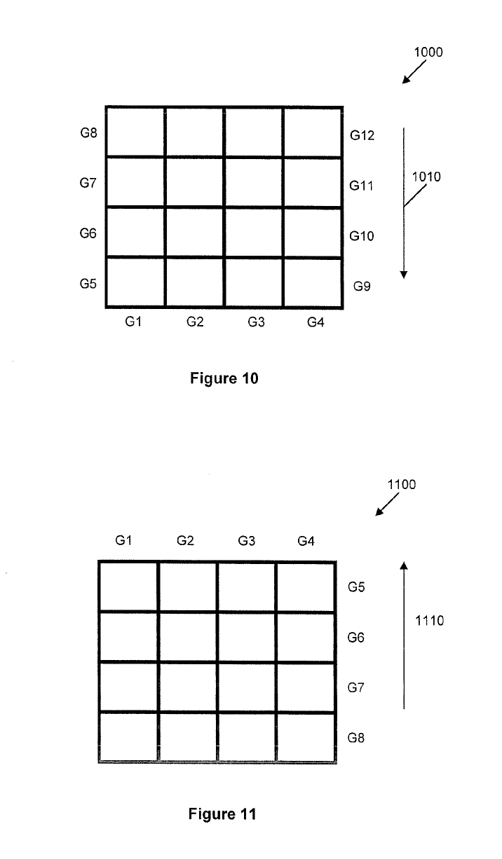

FIG. 10 shows a further example of a region in the form a rectangular array of 16 symbol display positions. In the embodiment of FIG. 10, the attraction direction is downwards towards the base of the region as indicated by arrow 1010.

In the example of FIG. 10, there are 12 gates provided in the bottom and both sides of the rectangular array of symbols and symbols can enter from any of these points. Accordingly, as in FIG. 9, the lowest row of symbol display positions running between gate 5 and gate 9 provide terminal display positions. However, the arrangement of FIG. 10 is such that depending on what symbols are inserted through which gates at what time, symbols may move towards a terminal display position as soon as they enter. It will be appreciated that in FIG. 8, the terminal display positions and the gates are arranged such that any symbol which is injected will only move to its symbol display position. In contrast in FIG. 10, if for example the first symbol were injected at gate 12, it would fall to the lowest symbol display position above entry point G4.

### Example 4

FIG. 11 shows another example of a rectangular array, this time having entry gates along the top of the array (gates G1 to G4) and along one side of the array (gates G5 to G8). In the example, the attraction direction is upwards as indicated by arrow 1110 towards the top of the array where the terminal display positions are located. Accordingly, symbols injected into the array, behave as if they float rather than falling downwards under the effect of gravity as in FIGS. 8 to 10.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of gaming comprising:
displaying a region comprising a plurality of symbol display positions on an electronic display, each symbol display position occupiable by one symbol at a time and being adjacent to at least one other symbol display position such that any movement of the symbols within the region involves a movement to an adjacent display position;
populating at least part of the region by injecting symbols into the region at respective selected entry points of a plurality of possible entry points to the region in a respective direction of entry, each entry point corresponding to one of the symbol display positions and the plurality of entry points collectively providing at least two different directions of entry,
each symbol injected into the region displacing any symbol occupying the symbol display position corresponding to the respective entry point and any further symbols at symbol display positions contiguous thereto in the respective direction of entry of the injected symbol, such that each displaced symbol either exits the region or moves, at least initially, into an adjacent symbol position in the entry direction of the injected symbol,
wherein any symbol continues to move upon being moved to an intermediate symbol display position having an empty adjacent symbol display position to which the respective symbol can move with a displacement having a component in a defined attraction direction, and
wherein one or more of the symbol display positions are terminal symbol display positions from which symbols cannot be displaced in the attraction direction such that any symbol moving in the attraction direction will come to rest either at a terminal display position or at an unoccupied symbol display position where the moving symbol cannot move further in the attraction direction because the moving would require displacement of a symbol from a terminal display position with a component in the attraction direction; and
evaluating the populated region to determine whether to make an award upon an evaluation condition being met.

2. A method as claimed in claim 1, wherein the evaluation condition is that all of the symbol display positions of the region are populated.

3. A method as claimed in claim 1, wherein the evaluation condition comprises a designated number of symbols having been injected into the region.

4. A method as claimed in claim 1, wherein the attraction direction is towards a bottom of the region.

5. A method as claimed in claim 4, wherein each symbol display position is a rhomboid and a subset of the symbol display positions provide a plurality of terminal display positions and a base upon which the remainder of the symbol display positions are stacked to define a plurality of rows of symbol display positions, an axis of each row crossing the axis of at least one other row transversely such that each row defines a slope down which symbols move when moving toward the direction of attraction.

6. A method as claimed in claim 5, wherein the entry points are into each symbol display position in the base row of symbol display positions.

7. A method as claimed in claim 6, wherein there are entry points in two directions into at least one of the symbol display positions in the base row of symbol display positions.

8. A method as claimed claim 6, wherein there are entry points in two directions into each one of the symbol display positions in the base row of symbol display positions.

9. A method as claimed in claim 1, wherein the symbol display positions are arranged in a rectangular array.

10. A method as claimed in claim 1, wherein the attraction direction is towards a top of the region.

11. A method as claimed in claim 10, wherein the symbol display positions are arranged in a rectangular array.

12. A method as claimed in claim 1, comprising randomly selecting the entry point for each symbol.

13. A method as claimed in claim 1, comprising randomly selecting the direction of entry for each symbol.

14. A method as claimed in claim 1, comprising randomly selecting each symbol from a set of symbols.

15. A method as claimed in claim 1, comprising displaying a symbol outside each region at each entry point such that a player can see each symbol which may be injected into the region.

16. A gaming system comprising:
an electronic display displaying a region comprising a plurality of symbol display positions on an electronic display, each symbol display position occupiable by one symbol at a time and being adjacent to at least one other symbol display position such that any movement of the symbols within the region involves a movement to an adjacent display position;
a symbol injector arranged to populate at least part of the region by injecting symbols into the region at respective selected entry points of a plurality of possible entry points to the region in a respective direction of entry, each entry point corresponding to one of the symbol display positions and the plurality of entry points collectively providing at least two different directions of entry;
a symbol displacement controller arranged to control displacement of symbols such that each symbol injected into the region displaces any symbol occupying the symbol display position corresponding to the respective entry point and any further symbols at symbol display positions contiguous thereto in the respective direction of entry of the injected symbol, such that each displaced symbol either exits the region or moves, at least initially, into an adjacent symbol position in the entry direction of the injected symbol,
the symbol displacement controller further arranged such that any symbol continues to move upon being moved to an intermediate symbol display position having an empty adjacent symbol display position to which the symbol can move with a displacement having a component in a defined attraction direction, wherein one or more of the symbol display positions are terminal symbol display positions from which symbols cannot be displaced in the attraction direction such that the symbol displacement controller causes any symbol moving in the attraction direction to come to rest either at a terminal display position or at an unoccupied symbol display position where the moving symbol cannot be moved further in the attraction direction because the moving would require displacement of a symbol from a terminal display position with a component in the attraction direction; and
a region evaluator, arranged to evaluate the populated region to determine whether to make an award upon an evaluation condition being met.

17. A gaming system as claimed in claim 16, wherein the evaluation condition is that all of the symbol display positions of the region are populated.

18. A gaming system as claimed in claim 16, wherein the evaluation condition comprises a designated number of symbols having been injected into the region.

19. A gaming system as claimed in claim 16, wherein the attraction direction is towards a bottom of the region.

20. A gaming system as claimed in claim 19, wherein each symbol display position is a rhomboid and a subset of the symbol display positions provide a plurality of terminal display positions and a base upon which the remainder of the symbol display positions are stacked to define a plurality of rows of symbol display positions, an axis of each row crossing the axis of at least one other row transversely such that each row defines a slope down which symbols move when moving toward the direction of attraction.

21. A gaming system as claimed in claim 20, wherein the entry points are into each symbol display position in the base row of symbol display positions.

22. A gaming system as claimed in claim 21, wherein there are entry points in two directions into at least one of the symbol display positions in the base row of symbol display positions.

23. A gaming system as claimed claim 21, wherein there are entry points in two directions into each one of the symbol display positions in the base row of symbol display positions.

24. A gaming system as claimed in claim 16, wherein the symbol display positions are arranged in a rectangular array.

25. A gaming system as claimed in claim 16, wherein the attraction direction is towards a top of the region.

26. A gaming system as claimed in claim 25, wherein the symbol display positions are arranged in a rectangular array.

27. A gaming system as claimed in claim 16, wherein the symbol injector is arranged to randomly select the entry point for each symbol.

28. A gaming system as claimed in claim 16, wherein the symbol injector is arranged to randomly select the direction of entry for each symbol.

29. A gaming system as claimed in claim 16, wherein the symbol injector is arranged to randomly select each symbol from a set of symbols.

30. A gaming system as claimed in claim 16, further arranged to display a symbol outside each region at each entry point such that a player can see each symbol which may be injected into the region.

31. A game controller for a gaming system, the game controller arranged to:
control an electronic display to display a region comprising a plurality of symbol display positions, each symbol display position occupiable by one symbol at a time and being adjacent to at least one other symbol display position such that any movement of the symbols within the region involves a movement to an adjacent display position;
populate at least part of the region by injecting symbols into the region at respective selected entry points of a plurality of possible entry points to the region in a respective direction of entry, each entry point corresponding to one of the symbol display positions and the plurality of entry points collectively providing at least two different directions of entry,
each symbol injected into the region displacing any symbol occupying the symbol display position corresponding to the respective entry point and any further symbols at symbol display positions contiguous thereto in the respective direction of entry of the injected symbol, such that each displaced symbol either exits the region or moves, at least initially, into an adjacent symbol position in the entry direction of the injected symbol,
wherein any symbol continues to move upon being moved to an intermediate symbol display position having an empty adjacent symbol display position to which the respective symbol can move with a displacement having a component in a defined attraction direction, and
wherein one or more of the symbol display positions are terminal symbol display positions from which symbols cannot be displaced in the attraction direction such that any symbol moving in the attraction direction will come to rest either at a terminal display position or at an unoccupied symbol display position where the moving symbol cannot move further in the attraction direction because the moving would require displacement of a symbol from a terminal display position with a component in the attraction direction; and
evaluate the populated region to determine whether to make an award upon an evaluation condition being met.

32. A game controller as claimed in claim 31, wherein the evaluation condition is that all of the symbol display positions of the region are populated.

33. A game controller as claimed in claim 31, wherein the evaluation condition comprises a designated number of symbols having been injected into the region.

34. A game controller as claimed in claim 31, arranged to randomly selecting the entry point for each symbol.

35. A game controller as claimed in claim 31, arranged to randomly selecting the direction of entry for each symbol.

36. A game controller as claimed in claim 31, arranged to randomly selecting each symbol from a set of symbols.

37. A game controller as claimed in claim 31, arranged to control the display to display a symbol outside each region at each entry point such that a player can see each symbol which may be injected into the region.

38. A gaming system comprising:
means for displaying a region comprising a plurality of symbol display positions, each symbol display position occupiable by one symbol at a time and being adjacent to at least one other symbol display position such that any movement of the symbols within the region involves a movement to an adjacent display position;
means for populating at least part of the region by injecting symbols into the region at respective selected entry points of a plurality of possible entry points to the region in a respective direction of entry, each entry point corresponding to one of the symbol display positions and the plurality of entry points collectively providing at least two different directions of entry,
each symbol injected into the region displacing any symbol occupying the symbol display position corresponding to the respective entry point and any further symbols at symbol display positions contiguous thereto in the respective direction of entry of the injected symbol, such that each displaced symbol either exits the region or moves, at least initially, into an adjacent symbol position in the entry direction of the injected symbol,
wherein any symbol continues to move upon being moved to an intermediate symbol display position having an empty adjacent symbol display position to which the respective symbol can move with a displacement having a component in a defined attraction direction, and
wherein one or more of the symbol display positions are terminal symbol display positions from which symbols cannot be displaced in the attraction direction such that any symbol moving in the attraction direction will come to rest either at a terminal display position or at an unoccupied symbol display position where the moving symbol cannot move further in the attraction direction because the moving would require displacement of a symbol from a terminal display position with a component in the attraction direction; and
means for evaluating the populated region to determine whether to make an award upon an evaluation condition being met.

39. A method as claimed in claim 1, further comprising executing computer program code for displaying said region, populating said at least part of the region, and evaluating the populated region.

40. A method as claimed in claim 39, further comprising storing said computer program code in a tangible computer readable medium.

41. A method as claimed in claim 39, further comprising transmitting the computer program code.
